(19) United States
(12) Patent Application Publication
(10) Pub. No.: US 2003/0177350 A1
(43) Pub. Date: Sep. 18, 2003

(54) Method of controlling network access in wireless environment and recording medium therefor

(76) Inventor: Kyung-Hee Lee, Yongin-City (KR)

Correspondence Address: LEE & STERBA, P.C., Suite 2000, 1101 Wilson Boulevard, Arlington, VA, 22209, US

(21) Appl. No.: 10/383,729

(22) Filed: Mar. 10, 2003

(30) Foreign Application Priority Data
Mar. 16, 2002 (KR) 2002-14276

(51) Int. Cl. H04L 9/00

(52) U.S. Cl. 713/155

(57) ABSTRACT

A network access controlling method in a wireless environment, including an access point completes authenticating a terminal using an MAC-ID. Next, a user inputs a password to a password authentication client. Then, authentication between the password authentication client and an authentication server is performed based on the input password. Thereafter, the terminal accesses an external/internal network (e.g., Internet/intranet) if the terminal authentication and the authentication based on the password are approved. Otherwise, the terminal transmits an authentication failure message to the user.

### BACKGROUND OF THE INVENTION

1. Field of the Invention

The present invention relates to a method of controlling access to a network and protecting communication data in a wireless environment. More particularly, the present invention relates to an access controlling method using a combination of a wireless local area network (hereinafter referred to as WLAN) terminal authentication and a user authentication.

2. Description of the Related Art

Generally, WLANs are LANs that transmit and receive data over the air between computers, or between a computer and a communication system other than a computer, without the need for wired connections. WLANS transmit and receive data using radio and infrared electromagnetic airwaves. WLANs have been developed with the recent rapid advancements of Internet services and wireless communication technologies. Because WLANs are easily installed and maintained, they are increasingly used for network connections between buildings and in places where establishing a wired network is difficult, such as in large-scale offices and distribution centers. However, WLANs provide poor security as compared to wired networks because, theoretically, anybody may access the transmission medium.

In this regard, many security services have been developed, such as encryption, access control, authentication, non-repudiation, integrity, etc., all of which are important. However, the authentication function is particularly important when considering quality communication services. In a WLAN, proper authentication is performed prior to encryption and access control. In a public WLAN, authentication with respect to a terminal is necessarily required to provide a WLAN service that charges users. However, in a WLAN system, the security function of a mechanism for authentication using an existing wired equivalent privacy (WEP) protocol does not work against many attacks.

An authentication mechanism in a conventional IEEE802.11b system is classified into two mechanisms, an open-system authentication mechanism and a shared-key authentication mechanism. Only the shared-key authentication mechanism performs authentication using an actual key. The open-system authentication mechanism uses an empty character stream opened upon a WLAN card authentication based on an access point. The access point may be connected to a WLAN card device after unconditionally authenticating the card device, even if the card device does not provide accurate authentication information. In the shared-key authentication mechanism, a particular character stream proposed by an access point to a WLAN card in a challenge procedure is coded into a predetermined key in a response procedure through a challenge-response communication. A pre-determined shared key is used to code the character stream in the response procedure before resuming communications. Then, the coded character stream may be connected to an access point only if it passes the authentication procedure, thereby obtaining an authentication to be transmitted from the WLAN card to the access point.

In an IEEE802.11b system, a terminal authenticates itself to an access point using a WEP supplied by a media access control (MAC) layer. In order to authenticate a terminal to an access point by improving an existing authentication mechanism, an IEEE802.11a system may adopt an authentication method using a WEP or a method of defining an authentication protocol in an IEEE802.1X environment identical to or superior to the MAC layer.

An authentication protocol using a WEP is based on a challenge-response method using algorithms for challenge and response procedures. In this method, when a terminal codes a challenge received at an access point using a shared key and a WEP and transmits the code to the access point, the access point decodes the challenge using a previously shared key, thereby authenticating the challenger. However, the authentication protocol using WEP offers no safety against attacks made on a current WEP algorithm.

The other authentication method proposed by an IEEE802.11a system is to authenticate a terminal on a level equal to or higher than an MAC layer. This authentication method is based on an authentication protocol using an extensible authentication protocol (EAP) in an IEEE802.1X environment, but requires a concrete authentication protocol in order to perform authentication at a level equal to or higher than the MAC layer. The IEEE802.1X environment does not define a concrete authentication protocol.

If the IEEE802.1X environment were to propose a concrete authentication protocol, the proposed concrete authentication protocol could be applied to provide a terminal authentication function. However, in a security service based on terminal authentication, an unauthorized user that acquired a terminal may access a network although he or she is not the original owner of the terminal. Therefore, user access to enterprise networks and public access services must be controlled.

Next-generation terminals provide access to several wireless links. When these access points are realized within a terminal, authentications for several wireless accesses are required. In order to receive a mutual exchange service of several wireless accesses, a terminal must support authentication for the mutual wireless access. To achieve this, wireless access techniques require an independent mechanism.

To authenticate a user, a password authentication method is convenient and therefore widely used. However, general authentication systems using a password provide a low degree of freedom for a user to select a password. When a password having a size of k bits is selected, and a probability that each of the k bits is 0 or 1 is 0.5, the k-bit password becomes an arbitrary random key. Guessing the random key means making a list of 2^{k random password candidates. However, when a user selects a password, random selection is almost impossible, and thus the user is exposed to an off-line password guessing attack.}

### SUMMARY OF THE INVENTION

In an effort to solve these and other problems, it is a feature of an embodiment of the present invention to provide a network access controlling method having improved security as compared to a conventional method by using both terminal authentication and user authentication in a place requiring authentication as a way of controlling network accesses through a terminal, such as in a wireless local area network service, and a recording medium for storing software codes of the network access controlling method.

To provide this feature of the present invention, there is provided a network access controlling method in a wireless environment, the method including completion of a terminal authentication using a MAC-ID by an access point, inputting of a password P by a user to a password authentication client, completion of authentication of a user by performing authentication between the password authentication client and an authentication server based on the password input by the user, and accessing an external or internal network such as the Internet or an intranet by the terminal, if the terminal authentication and the user authentication are approved, and transmitting an authentication failure message to the user if the terminal authentication and/or the user authentication are not approved.

The terminal authentication may be performed in an IEEE802.1X environment.

The network access controlling method may further include, if the user is the original possessor of the terminal, after the terminal authentication and before the inputting of the password, assigning the terminal an Internet Protocol (IP) address and downloading the password authentication client from the authentication server.

The network access controlling method may further include, as preparatory operations for the inputting of the password P, selecting an arbitrary large prime number n and obtaining a primitive element g for a mod n, the large prime number n and the primitive element g corresponding to information shared by the terminal and the authentication server, selection of the password P and calculation of a password verifier v=g^{h(P)} by the user, transmittal by the user of the password verifier v to the authentication server via a safe channel, wherein h(•) denotes a unidirectional hash function.

In the network access controlling method, performing authentication between the password authentication client and an authentication server may include calculation and storage of the password verifier v=g^{h(P)} by the password authentication client based on the password P input by the user, production by the password authentication client of three random values, which are a secret key x_{A} of the terminal, a confounder c_{A} of the terminal, and an arbitrary value r, and calculation of a public key y_{A}=g^{xA} of the terminal and a value z₁=h(y_{A}, v, c_{A}) using the secret key x_{A} and the confounder c_{A} of the terminal and the password verifier v, transmittal of the calculated values z₁ and y_{A} and the arbitrary value r by the password authentication client to the authentication server via the access point, performing storage of the received values z₁ and y_{A} and production of a secret key x_{B} of the authentication server by the authentication server to calculate a public key of the authentication server, y_{B}=g^{xB}, calculation of a session key K=y_{A}^{xB} and a value h₁=h(r, v, K), by the authentication server based on the received values y_{A} and r, transmittal by the authentication server to the password authentication client of a message z₂=Eᵥ(y_{B}, h₁), into which the public key y_{B} of the authentication server and the calculated value h₁ are encoded by a symmetric key encoding system by using a key derived from the password verifier v, the password authentication client decoding the received message z₂ using the symmetric key encoding system based on a decoding key derived from the password verifier v, calculating and storing a session key K=y_{B}^{xA}, calculating h′=h(r, v, K) using the calculated session key, decoding the calculated value h′, and determining if the decoded value h′ is equal to the received value h₁, if h′ is not equal to h₁, the password authentication client stopping message exchange with the authentication server, and if h′ is equal to h₁, the password authentication client transmitting, to the authentication server, a message z₃=E_{yB}(c_{A}, K), into which K=y_{B}^{xA} and c_{A} are encoded based on a key induced from the public key y_{B} of the authentication server, the authentication server decoding the received value z₃ using a key induced from y_{B} and stopping message exchange with the user authentication client if K=y_{B}^{xA} is not equal to K=A^{xB}, and if K=y_{B}^{xA} is equal to K=y_{A}^{xB}, calculating a value h″=h(y_{A}, v, c_{A}) based on the value y_{A} stored in and the decoded c_{A}, and determining if h″ is equal to z₁, and if h″ is equal to z₁, approval by the authentication server of a user authentication, and if h″ is not equal to z₁, disapproval of the user authentication by the authentication server, wherein Eₓ(•) denotes a symmetric key encoding algorithm using x as a secret key.

The present invention relates to a method of allowing a user's access to a network through “user authentication in a broad meaning”. The user authentication in a broad meaning may be understood as embracing both a method of controlling a user's access to a network by authenticating the terminal used by the user and a method of authenticating the user.

The method of controlling a user's access to a network through terminal authentication is performed in a situation when the user uses his or her dedicated terminal, such as a mobile phone. Obviously, the user's dedicated terminal has a unique identifier. The network authenticates the terminal using the terminal's unique identifier, allowing the user to access the network. This method provides easy access to the network, with no user participation in the authentication process. However, network access control using only terminal authentication poses security problems, in that any person acquiring access to the terminal may be allowed to access the network. That is, unauthorized users may access the network through other people's terminals. Also, terminal authentication is based on the identifier of a terminal and therefore, terminal authentication is dependent on the wireless link access technique of the terminal. As a result, terminal authentication is unable to use other wireless link access techniques.

On the other hand, user authentication is used to control a user's access to a network by authenticating the user regardless of which terminal the user uses. User authentication has a disadvantage in that the user must undergo an authentication process. However, user authentication is important in directly authenticating a user who actually accesses a network. In user authentication, it is possible to authenticate a user regardless of terminals and wireless link access techniques. A feature of the present invention is that user authentication is based on a password known by a user. The present invention provides easy control of network access at a user level.

### BRIEF DESCRIPTION OF THE DRAWINGS

The above features and advantages of the present invention will become more apparent to those of ordinary skill in the art by describing in detail preferred embodiments thereof with reference to the attached drawings in which:

FIG. 1 is a block diagram for illustrating a network access controlling method according to the present invention; and

FIG. 2 is a flowchart for illustrating a network access controlling method according to the present invention.

### DETAILED DESCRIPTION OF THE INVENTION

Korean Patent Application No. 2002-14276, filed on Mar. 16, 2002, and entitled: “Method Of Controlling Network Access In Wireless Environment And Recording Medium Therefor,” is incorporated by reference herein in its entirety.

The present invention will now be described more fully with respect to the accompanying drawings, in which a preferred embodiment of the invention is shown. This invention may, however, be embodied in different forms and should not be construed as limited to the embodiment set forth herein. Rather, the embodiment is provided so that this disclosure will be thorough and complete, and will fully convey the scope of the invention to those skilled in the art.

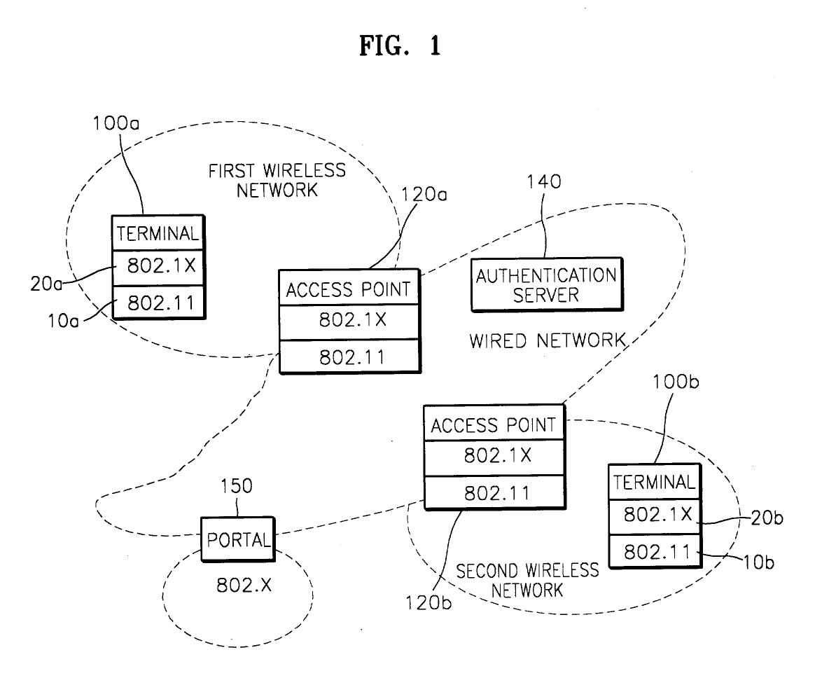

For user authentication, the present invention includes a step of authenticating a terminal possessed by a user and a step of authenticating the user using a password chosen by the user. Also, the main bodies of action, which are a terminal, an access point, and an authentication server existing in a network, are required to perform user authentication according to the present invention. FIG. 1 shows the components of a WLAN environment.

Referring to FIG. 1, terminals 100a and 100b have MAC protocol stacks 10a and 10b (e.g., IEEE802.11), respectively, and have frameworks 20a and 20b (e.g., IEEE802.1X), respectively, on a second layer. The MAC protocol stacks 10a and 10b are capable of accessing a wireless link, and the frameworks 20a and 20b enable authentication of a terminal. The terminals 100a and 100b include processors (not shown) for receiving a password from a user and processing the received password. The terminal 100a and an access point 120a constitute a first wireless network, and the terminal 100b and an access point 120b constitute a second wireless network. The terminals 100a and 100b are unable to access a host in a wired network without being authenticated by the access points 120a and 120b. The manner in which the access points 120a and 120b process packets of the terminals 100a and 100b differs depending on where the authentication is performed. For example, in an IEEE802.1X environment, authentication-related packets sent by the terminals 100a and 100b are transmitted to an authentication server 140 in the wired network without undergoing authentication by the access points 120a and 120b.

The access points 120a and 120b are required to access a wired network by a wireless access, and send an authentication-related packet using a password, which is used in the present invention, to the authentication server 140 in the wired network without any processing. In an IEEE802.1X environment, it is possible for an access point to simply perform an authentication server function, or to transmit an authentication-related packet to an authentication server while an authentication server in a LAN is assigned to perform a local authentication function.

The authentication server 140 processes authentication messages requested by the terminals 100a and 100b, and stores session information from the terminals 100a and 100b. Therefore, it is possible to charge a user based on the session information stored by the authentication server 140.

That is, the authentication server 140 stores personal information regarding users and records information regarding services used by the users.

In FIG. 1, reference numeral 150 denotes a portal.

Basic operations and parameters required to authenticate a user using a password are as follows.

n: arbitrary large prime number

g: primitive element for mod n

P: user's password

A, B: characters representing a user and an authentication server, respectively

v: a password verifier stored in an authentication server

x_{A}, x_{B}: arbitrary private keys of a user terminal and an authentication server, respectively

y_{A}, y_{B}: arbitrary public keys of a user terminal and an authentication server, respectively. Here, y_{A}=g^{xA}, and y_{B}=g^{xB} (where the uses of x_{A} and y_{A} are slightly different from those of a private key and a public key, respectively, which are used in a general public key coding system).

c_{A}: a confounder of a user terminal, generally long random value

h(•): a unidirectional hash function

Eₓ(•): a symmetric key coding algorithm in which x is used as a private key. Since x can have an arbitrary length, a coding algorithm having a key of variable size, such as Blowfish [Sch93], may be used for security, and an Advanced Encryption Standard (AES) newly established as a block coding algorithm standard by the U.S. National Institute of Standard and Technology may also be used.

K: a session key that is shared by a user and an authentication server and may be used for encryption communications later.

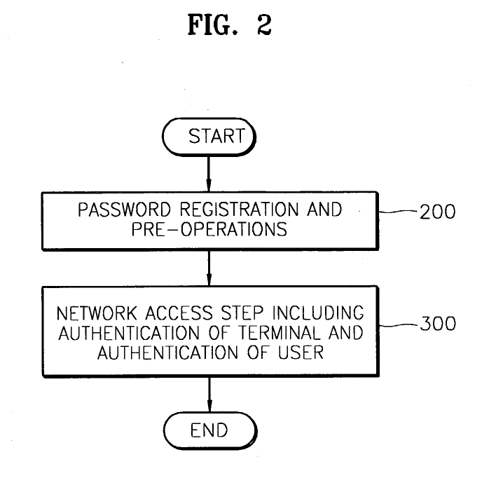

Referring to FIG. 2, a method of controlling user access to a network according to an embodiment of the present invention, includes two steps. First, authentication for a terminal is performed. Next, authentication for a user of the terminal is performed using a password, in step 300. Authentication for the user of a terminal using a password is performed after the following preparatory operations in step 200.

[Step 200 for password registration and preparatory operations]

First, the primitive element g for the mod n is obtained by selecting the arbitrary large prime number n. Here, n and g correspond to information shared by a user terminal and an authentication server.

Next, a user selects his or her password P and calculates the password verifier v=g^{h(P)}. As described above, h(•) is a unidirectional hash function.

Thereafter, the user transmits the value of the password verifier v to the authentication server via a safe channel.

A process in which the user acquires a terminal for the first time and gains authentication from the authentication server will now be described. If the user is not the first user in a certain domain, the fourth sub-step in step 300 for network access may be omitted.

[Step 300 for network access]

In the first sub-step, authentication of a terminal is completed using an MAC-ID in an IEEE802.1X environment.

In the second sub-step, an Internet Protocol (IP) address is allocated using a dynamic host configuration protocol (DHCP) server or the like.

In the third sub-step, the address of the authentication server is brought up.

In the fourth sub-step, the authentication server downloads a password authentication client.

In the fifth sub-step, a user inputs his or her password to the password authentication client.

In the sixth sub-step, authentication between the password authentication client and the authentication server is completed based on the password input by the user.

In the seventh sub-step, the terminal accesses an external/internal network, such as the Internet or an intranet, after authentication is approved.

Hereinafter, the sixth sub-step of step 300 (network access) will be described in greater detail. Step 200 (password registration and preparatory operations) must be performed before the sixth sub-step for authentication.

In the sixth sub-step, first, the password authentication client calculates a password verifier v=g^{h(P)}, based on a password P input by the user.

Second, the password authentication client produces three random values x_{A}, c_{A}, and r.

Third, y_{A}=g^{xA} and z₁=h(y_{A}, v, c_{A}) are calculated using the produced random values.

Fourth, the password authentication client transmits the values z₁, y_{A}, and r to the authentication server via an access point.

Fifth, the authentication server stores the received values z₁ and y_{A} and produces a random value x_{B} to calculate y_{B}=g^{xB}.

Sixth, the authentication server calculates a session key K=y_{A}^{xB} and a value h₁=h(r, v, K), based on the received values y_{A} and r.

Seventh, the authentication server transmits to the password authentication client a message z₂=Eᵥ(y_{B}, h₁), into which the public key y_{B} of the authentication server and the calculated value h₁ are encoded by a symmetric key encoding system by using a key derived from the password verifier v of the user. Here, the length of a required key differs according to a symmetric key encoding system used, but the length of a key required by the password verifier may start from the most significant bit (MSB).

Eighth, the password authentication client decodes the received encoded message z₂ using the symmetric key encoding system based on a decoding key derived from the password verifier v of the user, and calculates and stores a session key K=y_{B}^{xA}. Thereafter, the password authentication client calculates a value h′=h(r, v, K) using the calculated session key and determines if the calculated value h′ is equal to the received value h₁. If h′ and h₁ are not equal, the password authentication client stops a message exchange with the authentication server.

Ninth, if h′ and h₁ are equal, the password authentication client transmits, to the authentication server, a message z₃=E_{yB}(c_{A}, K), into which K=y_{B}^{xA} and C_{A} are encoded based on a key derived from the public key y_{B} of the authentication server. A required key length starting from the MSB of y_{B} is obtained according to the used symmetric key encoding system.

Tenth, the authentication server decodes the received z₃ using a key derived from y_{B} and determines if K=y_{B}^{xA} is equal to K=y_{A}^{xB}. If K=y_{B}^{xA} is not equal to K=y_{A}^{xB}, the authentication server stops a message exchange with the user authentication client. If K=y_{B}^{xA} is equal to K=y_{A}^{xB}, the authentication server calculates a value h″=h(y_{A}^{, v, c}_{A}) based on y_{A} stored in the fifth step and the decoded c_{A} and determines if h″ is equal to z₁. If h″ is equal to z₁, the authentication server transmits a user authentication success message to the password client. If h″ is not equal to z₁, the authentication server transmits a user authentication failure message to the password client.

After authentication between the password authentication client and the authentication server is completed, new secrete information enabling encryption communications are shared by the user and the authentication server.

As described above, by the present invention, a user may be authenticated by using a password in a WLAN environment. Therefore, regardless of the number of wireless accesses available, a user may be authenticated, thereby allowing a terminal to be authenticated even when it roams over a variety of networks.

The use of passwords in the present invention, as opposed to conventional management using a media access control identifier (MAC-ID), makes both user-level management and an inter-technology hand off function possible. Mutual authentication is also possible without a public key infrastructure (PKI). An Internet key exchange (IKE), which is an authentication protocol used in IP security (IPSec), depends on the PKI or an equivalent in order to authenticate an opposite party. However, the present invention uses a password-dependent authentication method, so that an authentication system may be easily established without the PKI. Accordingly, authentication by the present invention is efficiently performed.

According to the present invention, it is possible to determine whether a user has the same key as that of an authentication server. Communication data protected by the present invention is safe from password attacks worked in a conventional system using a general password. In the present invention, authentication of a terminal and a user are performed independently, thereby adding an extra layer of protection. Further, after authentication of a terminal and a client, the present invention provides shared secret information, with which encoding communications are performed. Finally, in the method of the present invention, a key known in any session does not include information on a key used in any other session.

A protocol for mutual authentication and key exchange between a user and an authentication server, according to the present invention, mainly performs a hash function and a symmetric encoding algorithm except when each host performs modular exponentiation one time to achieve a Diffe-Hellman key exchange. Thus, fast authentication and key exchange are realized.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A network access controlling method in a wireless environment, the method comprising:
(a) completion of a terminal authentication using a MAC-ID by an access point;
(b) inputting of a password P by a user to a password authentication client;
(c) completion of authentication of a user by performing authentication between the password authentication client and an authentication server based on the password P input by the user; and
(d) accessing an external or internal network such as the Internet or an intranet by the terminal if the terminal authentication and the user authentication are approved, and transmitting an authentication failure message to the user if the terminal authentication and/or the user authentication are not approved.

2. The network access controlling method as claimed in claim 1, wherein (a) is performed in an IEEE802.1X environment.

3. The network access controlling method as claimed in claim 1, further comprising, if the user is the original possessor of the terminal, between (a) and (b):
assigning the terminal an Internet Protocol (IP) address; and
downloading the password authentication client from the authentication server.

4. The network access controlling method as claimed in claim 1, further comprising as preparatory operations for (b):
(b-1) selecting an arbitrary large prime number n and obtaining a primitive element g for a mod n, the large prime number n and the primitive element g corresponding to information shared by the terminal and the authentication server;
(b-2) selection of the password P and calculation of a password verifier v=g^{h(P)} by the user; and
(b-3) transmittal by the user of the password verifier v to the authentication server via a safe channel,
wherein h(•) denotes a unidirectional hash function.

5. The network access controlling method as claimed in claim 1, wherein (c) comprises:
(c-1) calculation and storage of the password verifier v=g^{h(P)} by the password authentication client based on the password P input by the user;
(c-2) production by the password authentication client of three random values, which are a secret key x_{A} of the terminal, a confounder c_{A} of the terminal, and an arbitrary value r, and calculation of a public key y_{A=g}^{xA} of the terminal, and a value z₁=h(y_{A}, v, c_{A}) using the secret key x_{A} and the confounder c_{A} of the terminal and the password verifier v;
(c-3) transmittal of the calculated values z₁ and y_{A} and the arbitrary value r by the password authentication client to the authentication server via the access point;
(c-4) performing storage of the received values z₁ and y_{A} and production of a secret key x_{B} of the authentication server by the authentication server to calculate a public key of the authentication server, y_{B}=g^{xB};
(c-5) calculation of a session key K=y_{A}^{xB}, and a value h₁=h(r, v, K), by the authentication server based on the received values y_{A} and r;
(c-6) transmittal, by the authentication server to the password authentication client, of a message z₂=Eᵥ(y_{B}, h₁), into which the public key y_{B} of the authentication server and the calculated value h₁ are encoded by a symmetric key encoding system by using a key derived from the password verifier v;
(c-7) the password authentication client decoding the received message z₂ using the symmetric key encoding system based on a decoding key derived from the password verifier v, calculating and storing a session key K=y_{B}^{xA}, calculating a value h′=h(r, v, K) using the calculated session key, decoding the calculated value h′, and determining if the decoded value h′ is equal to the received value h₁;
(c-8) if h′ is not equal to h₁, the password authentication client stopping message exchange with the authentication server, and if h′ is equal to h₁, the password authentication client transmitting, to the authentication server, a message z₃=E_{yB}(c_{A}, K), into which K=y_{B}^{xA} and c_{A} are encoded based on a key derived from the public key y_{B} of the authentication server;
(c-9) the authentication server decoding the received value z₃ using a key derived from y_{B} and stopping message exchange with the user authentication client if K=y_{B}^{xA} is not equal to K=y_{A}^{xB}, and if K=y_{B}^{xA} is equal to K=y_{A}^{xB}, calculating a value h″=h(y_{A}^{, v, c}_{A}_{) based on the value y}_{A} ^{stored in (c-}4) and the decoded c_{A}, and determining if h″ is equal to z₁; and
(c-10) if h″ is equal to z₁, approval by the authentication server of a user authentication, and if h″ is not equal to z₁, disapproval of the user authentication by the authentication server,
wherein Eₓ(•) denotes a symmetric key encoding algorithm using x as a secret key.

6. A computer readable recording medium that stores a computer program for executing the method claimed in claim 1.

7. A computer readable recording medium that stores a computer program for executing the method claimed in claim 2.

8. A computer readable recording medium that stores a computer program for executing the method claimed in claim 3.

9. A computer readable recording medium that stores a computer program for executing the method claimed in claim 4.

10. A computer readable recording medium that stores a computer program for executing the method claimed in claim 5.
